(19) United States
(12) Patent Application Publication
(10) Pub. No.: US 2023/0193046 A1
(43) Pub. Date: Jun. 22, 2023

(54) Powder Paint Composition

(71) Applicant: Wacker Chemie AG, Munich (DE)

(72) Inventors: Lada BEMERT, Winhöring (DE); Stefan BAUEREGGER, Burgkirchen (DE); Ulf DIETRICH, Burghausen (DE); Hans-Peter WEITZEL, Reischach (DE)

(73) Assignee: Wacker Chemie AG, Munich (DE)

(21) Appl. No.: 17/921,992

(22) PCT Filed: May 5, 2020
(86) PCT No.: PCT/EP2020/062413

§ 371 Date: Oct. 28, 2022

(51) Int. Cl. C09D 5/03; C09D 5/02; C09D 7/20; C09D 133/10; C09D 133/08; B05D 1/12

(52) U.S. Cl. CPC C09D 5/035; B05D 1/12; C09D 5/022; C09D 7/20; C09D 133/08; C09D 133/10; B05D 2401/20; B05D 2502/00

(57) ABSTRACT

Powder paint composition, processes for preparing and uses for the same. The composition includes (a) at least one polymer powder redispersible in water, (b) pigment and filler and (c) optionally further additives. Where (a) is a polymer stabilized with polyvinyl alcohol, based on (a1) 20 to 100% by weight of at least one monomer from the group consisting of acrylic esters of branched or unbranched alcohols having 1 to 12 carbon atoms, (a2) 0 to 60% by weight of at least one monomer from the group consisting of methacrylic esters of branched or unbranched alcohols having 1 to 12 carbon atoms and styrene, (a3) 0 to 40% by weight of at least one monomer from the group consisting of vinyl esters of branched or unbranched carboxylic acids having 2 to 12 carbon atoms, and (a4) 0 to 20% by weight of other ethylenically unsaturated comonomers copolymerizable therewith.

The invention relates to a powder paint composition, a process for the production thereof and the use of the powder paint composition for producing emulsion paints.

Synthetic resin emulsion paints or colloquially emulsion paints belong to the most widely used product group of lacquers and paints because of their ease of processing, the universal design options (coloring, effects) and for reasons of environmental protection (avoidance of solvent emissions). The main application of emulsion paints is as wall paint indoors and outdoors.

Emulsion paints have a long shelf life if the container is closed. However, once the container has been opened, microorganisms quickly get into the emulsion paint, which can lead to biological degradation thereof and the formation of mold. To protect against bacterial infestation, preservatives such as isothiazolinones are therefore used in emulsion paints, which can cause irritation and skin irritation, especially in allergy sufferers. Alternatively, a very strongly alkaline pH of up to pH = 13 is set in the emulsion paint. Such highly alkaline emulsion paints can also lead to irritation and damage to the skin. Therefore, elaborate precautions for occupational safety are necessary.

With the use of a dry powder paint, the composition of which corresponds to the composition of the emulsion paint except for the water content, the disadvantages mentioned above could be overcome. A water-free powder paint does not require protection from contamination during storage. Therefore, a dry powder paint can be stored and transported within a much wider temperature range and over a much longer period of time than with aqueous emulsion paint formulations. Another advantage of transporting a powder paint composition is that the weight of the paint is reduced due to the lack of water content. It is also advantageous that the required amount of aqueous emulsion paint can be produced with a powder paint composition during processing, and the remainder of the powder paint can be further stored. The volume of paint residues to be disposed of is thus effectively reduced.

DE 4300319 C1 describes a water-soluble paint powder with which an emulsion paint can be produced by adding water. A copolymer of vinyl acetate and ethylene is proposed as binder. DE 19751553 A1 describes aqueous dispersions and water-redispersible polymer powders, comprising a crosslinkable polymer with polyethylenically unsaturated monomer units, as binders for emulsion paints and powder paints and renders. EP 671435 B1 describes pulverulent, redispersible binders for paints which are obtained by spray drying an acrylate dispersion in the presence of a copolymer of water-insoluble comonomers and water-soluble, salt-forming comonomers. EP 1449892 B1 describes a pulverulent coating composition comprising a redispersible, granulated resin powder and at least one granulated color material. The resin powder is obtained by subjecting an emulsion of a vinyl acetate resin, ethylene vinyl acetate resin or (acrylic)styrene resin to a spray drying process to form a powder. WO 2012/007057 describes redispersible, cement-free mortars and renders with dispersion powder based on acrylate or styrene-acrylate polymers and with coalescent, filler and sand, and optionally other additives such as biocide. US 8580866 discloses a dry render composition with a redispersible acrylate polymer powder with CaCOs filler, coalescent and alkali metal hydroxide for pH adjustment. EP 2660294 B1 describes an inorganic dry powder building paint comprising a silicate, a silicate hardener and a redispersible polymer powder. EP 2909255 describes a dispersion powder based on acrylate polymers, which are obtained in a multi-stage polymerization process and can be used as binders for coating materials. In this case, an alkali-soluble polymer is produced in a first stage in the presence of emulsifier and an acrylate polymer is produced in its presence in one or more further stages in the presence of emulsifier. The dispersion thus obtained is admixed with base and then spray-dried. EP 3157992 describes the use of emulsifier-stabilized styrene-acrylate polymers, which are functionalized with silane-functional and carboxyl-functional monomers, as binders in paints.

The object was to provide a powder paint composition, the use of which in the production of emulsion paints yields coating agents with which paints with high wet abrasion resistance and high opacity are obtained.

The invention relates to a powder paint composition comprising a) at least one polymer powder redispersible in water, b) pigment and filler, and c) optionally further additives, characterized in that the polymer powder redispersible in water a) is a polymer stabilized with polyvinyl alcohol, based on a1) 20 to 100% by weight of at least one monomer from the group consisting of acrylic esters of branched or unbranched alcohols having 1 to 12 carbon atoms, a2) 0 to 60% by weight of at least one monomer from the group consisting of methacrylic esters of branched or unbranched alcohols having 1 to 12 carbon atoms and styrene, a3) 0 to 40% by weight of at least one monomer from the group consisting of vinyl esters of branched or unbranched carboxylic acids having 2 to 12 carbon atoms, a4) 0 to 20% by weight of other ethylenically unsaturated comonomers copolymerizable therewith, based in each case on the total weight of the comonomers and where the figures in % by weight add up to 100% by weight in each case, and the polyvinyl alcohol present is a mixture of at least one polyvinyl alcohol having a degree of hydrolysis of 80 to 95 mol% and a Höppler viscosity (4% aqueous solution, Höppler method at 20° C., DIN 53015) of 1 to 5 mPas and at least one polyvinyl alcohol having a degree of hydrolysis of 80 to 95 mol% and a Höppler viscosity of 6 to 40 mPas.

Water-redispersible polymer powder compositions (dispersion powder) are generally prepared by drying the corresponding aqueous dispersions of a base polymer. The aqueous dispersion of the base polymer is preferably prepared by means of free-radically initiated emulsion polymerization of one or more ethylenically unsaturated monomers. The resulting aqueous dispersion of the base polymer is then dried, preferably in the presence of a drying aid (generally a protective colloid), for example by means of spray drying. Optionally, antiblocking agents or other additives can also be added during or after drying. Because of the protective colloid content, irreversible adhesion of the polymer particles is firstly prevented in the course of the drying operation, since the polymer particles are encased by the protective colloid particles. Secondly, this protective colloid matrix, which redissolves when the polymer powder composition is dispersed in water, has the effect that the polymer particles are again present in the aqueous (re)dispersion with the particle size of the starting dispersion (TIZ-Fachberichte, 1985, Vol. 109 (9), 698).

The water-redispersible polymer powder (dispersion powder) a) is obtained by free-radically initiated aqueous emulsion polymerization of the comonomers a1), and optionally a2), a3) and a4) and subsequent drying of the resulting aqueous dispersion of the copolymer.

In general, a1) 20 to 100% by weight, preferably 30 to 70% by weight, of at least one monomer from the group consisting of acrylic esters of branched or unbranched alcohols having 1 to 12 carbon atoms are copolymerized, based in each case on the total weight of the comonomers. Preferred acrylic esters are methyl acrylate, ethyl acrylate, propyl acrylate, n-butyl acrylate, t-butyl acrylate, 2-ethylhexyl acrylate. Particular preference is given to methyl acrylate, n-butyl acrylate, and 2-ethylhexyl acrylate.

In general, a2) 0 to 60% by weight, preferably 30 to 60% by weight, of at least one monomer from the group consisting of methacrylic esters of branched or unbranched alcohols having 1 to 12 carbon atoms and styrene are copolymerized, based in each case on the total weight of the comonomers. Preferred methacrylic acid esters are methyl methacrylate, ethyl methacrylate, propyl methacrylate, n-butyl methacrylate. Particular preference is given to methyl methacrylate and styrene.

In general, a3) 0 to 60% by weight, preferably 5 to 40% by weight, of at least one monomer from the group consisting of vinyl esters of branched or unbranched carboxylic acids having 2 to 12 carbon atoms are copolymerized, based in each case on the total weight of the comonomers. Preferred vinyl esters a3) are vinyl acetate, vinyl propionate, vinyl butyrate, vinyl 2-ethylhexanoate, vinyl laurate, 1-methylvinyl acetate, vinyl pivalate, vinyl esters of neodecanoic acid, and vinyl esters of alpha-branched monocarboxylic acids having 5 to 12 carbon atoms, for example VeoVa9^{R} or VeoVa10^{R} (trade names of Resolution) or VERSA10^{R} (trade name of Wacker Chemie AG). Particular preference is given to vinyl acetate, vinyl laurate, vinyl esters of neodecanoic acid and the vinyl esters of alpha-branched carboxylic acids having 9 or 10 carbon atoms (VeoVa9^{R}, VeoVa10^{R} or VERSA10^{R}). Vinyl acetate and vinyl laurate are most preferred.

In general, a4) 0 to 20% by weight, preferably 0.1 to 10% by weight, of further ethylenically unsaturated comonomers which may be copolymerized therewith are copolymerized, based in each case on the total weight of the comonomers.

Examples of other comonomers a4) (auxiliary monomers a4) that may be copolymerized therewith are ethylenically unsaturated mono- and dicarboxylic acids, preferably acrylic acid, methacrylic acid and fumaric acid; ethylenically unsaturated carboxylic acid amides and carboxylic acid nitriles, preferably acrylamide and acrylonitrile; diesters of fumaric acid such as the diethyl and diisopropyl esters, ethylenically unsaturated sulfonic acids and salts thereof, preferably vinylsulfonic acid, 2-acrylamido-2-methylpropanesulfonic acid. Further examples are pre-crosslinking comonomers such as polyethylenically unsaturated comonomers, for example divinyl adipate, diallyl maleate, allyl methacrylate or triallyl cyanurate, or post-crosslinking comonomers, for example acrylamidoglycolic acid (AGA), methyl methylacrylamidoglycolate (MMAG), N-methylolacrylamide (NMA), N-methylolmethacrylamide (NMMA), N-methylol allyl carbamate, alkyl ethers such as the isobutoxy ether or ester of N-methylol acrylamide, of N-methylol methacrylamide, and of N-methylol allyl carbamate. Also suitable are epoxy-functional comonomers such as glycidyl methacrylate (GMA) and glycidyl acrylate. Further examples are silicon-functional comonomers, such as acryloyloxypropyltrialkoxy and -methacryloyloxypropyltrialkoxy silanes, vinyltrialkoxysilanes and vinylmethyldialkoxysilanes, wherein it is possible for the alkoxy groups to be present for example in the form of methoxy radicals, ethoxy radicals, and ethoxypropylene glycol ether radicals, especially vinyltrimethoxysilane and vinyltriethoxysilane and methacryloyloxypropyltrimethoxysilane. Mention should also be made of monomers having hydroxy or CO groups, for example hydroxyalkyl methacrylates and acrylates such as hydroxyethyl, hydroxypropyl or hydroxybutyl acrylate or methacrylate, and also compounds such as diacetone acrylamide and acetylacetoxyethyl acrylate or methacrylate. Further examples include also vinyl ethers such as methyl, ethyl, or isobutyl vinyl ether.

Preferred auxiliary monomers a4) are ethylenically unsaturated mono- and dicarboxylic acids such as acrylic acid, methacrylic acid and maleic acid (anhydride), ethylenically unsaturated sulfonic acids and salts thereof such as vinylsulfonic acid, epoxide-functional comonomers such as glycidyl methacrylate, silicon-functional comonomers such as vinyltrimethoxysilane, vinyltriethoxysilane and methacryloyloxypropyltrimethoxysilane, and mixtures of the auxiliary monomers mentioned. Preferably, no polyethylenically unsaturated comonomers are copolymerized.

Particularly preferred are the epoxide-functional and silicon-functional comonomers, and combinations of epoxide-functional and silicon-functional comonomers a4).

Preference is given to polymers of 90 to 100% by weight of at least one monomer a1) and optionally also 0.1 to 10% by weight of one or more auxiliary monomers a4). The figures in percentages by weight relate in each case to the total weight of the comonomers and add up to 100% by weight in each case. The polymers of n-butyl acrylate or 2-ethylhexyl acrylate or mixtures thereof, optionally with one or more auxiliary monomers a4), are particularly preferred.

Preference is also given to copolymers of 30 to 70% by weight of at least one monomer a1), 30 to 60% by weight of at least one monomer a2) and optionally also 0.1 to 10% by weight of one or more auxiliary monomers a4). Particular preference is given to the copolymers of n-butyl acrylate and/or 2-ethylhexyl acrylate as monomer a1) with methyl methacrylate and/or styrene as monomer a2) and optionally also 0.1 to 10% by weight of one or more auxiliary monomers a4).

Preference is also given to copolymers of 30 to 70% by weight of at least one monomer a1), 30 to 60% by weight of at least one monomer a2), 5 to 40% by weight of at least one monomer a3), and optionally also 0.1 to 10% by weight of one or more auxiliary monomers a4). Particular preference is given to the copolymers of n-butyl acrylate and/or 2-ethylhexyl acrylate as monomer a1) with methyl methacrylate and/or styrene as monomer a2) and vinyl acetate and optionally further vinyl esters other than vinyl acetate as monomer a3), and optionally also 0.1 to 10% by weight of one or more auxiliary monomers a4).

The aqueous dispersions of the polymer are prepared by the emulsion polymerization process, wherein the polymerization temperature is generally from 40° C. to 120° C., preferably 60° C. to 90° C., and wherein the pressure is generally 5 to 100 bar abs. The polymerization is preferably initiated with the redox initiator combinations which are commonly used for emulsion polymerization. Examples of suitable oxidation initiators are the sodium, potassium and ammonium salts of peroxodisulfuric acid and hydrogen peroxide. The initiators mentioned are generally used in an amount of 0.01 to 2.0% by weight, based on the total weight of the monomers. Examples of suitable reducing agents are, for example, sodium hydroxymethanesulfinate (Bruggolite) and (iso)ascorbic acid. The amount of reducing agent is preferably 0.01 to 3% by weight, based on the total weight of the monomers. The oxidizing agents mentioned, in particular the salts of peroxodisulfuric acid, can also be used alone as thermal initiators.

The polymerization is carried out in the presence of 2 to 10% by weight, based on the total weight of the comonomers, of one or more partially hydrolyzed and low molecular weight polyvinyl alcohols having a degree of hydrolysis of 80 to 95 mol% in each case and a Höppler viscosity, in 4% aqueous solution, of 1 to 5 mPas in each case (Höppler method at 20° C., DIN 53015). The degree of hydrolysis of the partially hydrolyzed and low molecular weight polyvinyl alcohols is preferably 85 to 90 mol%, particularly preferably 87 to 89 mol%. The Höppler viscosity in a 4% aqueous solution of the partially hydrolyzed and low molecular weight polyvinyl alcohols is preferably 2 to 4 mPas (Höppler method at 20° C., DIN 53015). Optionally, partially hydrolyzed and high molecular weight polyvinyl alcohols having a degree of hydrolysis of preferably 80 to 95 mol% and a Höppler viscosity in 4% aqueous solution of 6 to 40 mPas (Höppler method at 20° C., DIN 53015) may also be used alone or in a mixture with the partially hydrolyzed and low molecular weight polyvinyl alcohols. The polyvinyl alcohols mentioned are commercially available and are accessible to those skilled in the art by known methods.

Optionally, small amounts of emulsifiers, for example anionic and/or non-ionic emulsifiers, can also be used in the polymerization, for example 0.1 to 2.0% by weight, based on the total weight of the comonomers. Examples of anionic emulsifiers are alkyl sulfates having a chain length of 8 to 18 carbon atoms, alkyl or alkylaryl ether sulfates having 8 to 18 carbon atoms in the hydrophobic radical and up to 40 ethylene oxide or propylene oxide units, alkyl or alkylaryl sulfonates having 8 to 18 carbon atoms, esters and monoesters of sulfosuccinic acid with monohydric alcohols. Examples of non-ionic emulsifiers are C₁₂-C₁₄-fatty alcohol ethoxylates having a degree of ethoxylation of 3 to 20 ethylene oxide units. Preferably, no emulsifiers are used during the polymerization, and also no emulsifiers are added afterwards.

The water-redispersible polymer powder (dispersion powder) a) is prepared by drying the corresponding aqueous dispersions of the polymer. Drying is carried out by spray drying in the presence of the mixture of at least one polyvinyl alcohol having a degree of hydrolysis of 80 to 95 mol% and a Höppler viscosity of 1 to 5 mPas, and at least one polyvinyl alcohol having a degree of hydrolysis of 80 to 95 mol% and a Höppler viscosity of 6 to 40 mPas. The polyvinyl alcohols are used here in such an amount that their proportion by weight in the dispersion powder is 2 to 30% by weight, based on the weight of the polymer. The ratio of the proportion of low-viscosity polyvinyl alcohol to higher-viscosity polyvinyl alcohol is from 1: 50 to 50: 1, preferably from 1: 10 to 10: 1.

Spray drying is effected by means of atomization in the spray dryer. The drying gas used is generally air. To accelerate the drying, the drying gas is preheated, preferably to an inlet temperature of 130° C. to 210° C. (hot air). In general, an antiblocking agent is also added. Suitable antiblocking agents (anticaking agents) are known to those skilled in the art, for example aluminum silicates such as kaolin, fumed silica or precipitated silica or carbonates such as calcium carbonate or magnesium carbonate. The antiblocking agents are used generally in an amount of 0.1 to 30% by weight, preferably 2 to 30% by weight, particularly preferably 7 to 30% by weight, based in each case on the total weight of the polymeric constituents (polymer and polyvinyl alcohols) of the polymer dispersion to be atomized. Optionally, the antiblocking agent can also be added in whole or in part to the finished dried polymer powder before or after its separation from the drying gas.

The powder paint composition generally comprises 5 to 30% by weight, preferably 20 to 30% by weight, of one or more polymer powders redispersible in water a), based in each case on the total weight of the powder paint composition.

To optimize the viscosity and to optimize the opacity of the emulsion paints obtainable with the powder paints, polymer powders redispersible in water a) having a polyvinyl alcohol content of 10 to 30% by weight, preferably 20 to 30% by weight, in each case based on the weight of the copolymer, are preferably used in the powder paint formulation. These polymer powders redispersible in water a) with an increased polyvinyl alcohol content can be used alone or in a mixture with a polymer powder redispersible in water a) having a lower polyvinyl alcohol content, in the powder paint formulation.

The powder paint composition may also comprise one or more mineral binders, for example cement (Portland, aluminate, slag, magnesia, phosphate cement), gypsum, lime and water glass. The proportion of mineral binder is preferably 0.1 to 10% by weight, based on the total weight of the powder paint composition. By adding cement or lime to the dry formulation, the pH of a powder paint can also be specifically adjusted and as required.

In addition to the polymeric binder a) and optionally mineral binder b), a powder paint also comprises pigments and fillers and optionally also additives c) such as wetting and dispersing agents, thickeners, defoamers and pH adjusters.

Suitable pigments and proportions thereof in a powder paint formulation are known to those skilled in the art. Examples of pigments are inorganic pigments such as titanium dioxide, barium sulfate, boron nitride and zinc oxide for white emulsion paints. The proportion of pigments in the powder paint composition is generally 1 to 35% by weight, preferably 5 to 15% by weight, based in each case on the total weight of the powder paint composition.

In order to achieve a certain reproducible shade of a color, pigments have to be comminuted to a certain particle diameter and incorporated homogeneously into the color base. The comminution requires the use of special equipment, such as pigment mills. The pigment is then incorporated into the paint in a dispersing step. Because of the complexity of this process, preference is given to producing pigment preparations (water- or solvent-based) in which the pigments are already comminuted to the required diameter, and these solid-liquid dispersions are stabilized with surfactants. The incorporation of such a paste is much easier and does not require a high input of energy, and mixing to complete homogenization is sufficient. It is possible to use such an aqueous-based pigment paste to tint a powder paint after the addition of water, shortly before application.

However, such pigment pastes comprise biocides that are emitted into indoor air and can cause allergies. For this reason, it is advisable to select pigments for incorporation that can be used for tinting in a biocide-free and dry form without high shear force. Such pigments are known as easy-to-disperse pigment powders. With easy-to-disperse (ED) pigment powders, the particle surface is modified with surfactant/dispersing agent, which reduces the surface energy to a minimum, for example in an aqueous medium, and allows pigments to be incorporated into the paint formulation at very low shear force. Already available on the market are known ED pigment powders from Clariant (EDS and EDW pigments) and from BASF (X-Fast).

If tinting is dispensed with and the white color is retained, it is possible to use surface-modified easy-to-disperse titanium dioxide (for example Kronos 2190 or Tronox 828E) or titanium dioxide substitute products based on zinc sulfide and combinations thereof with barium sulfate, kaolins, hexagonal boron nitride.

Suitable fillers are, for example, carbonates such as calcium carbonate in the form of chalk, dolomite and calcite. Silicates such as quartz flour, feldspar, kaolin and talc are also suitable. Also suitable are fiber fillers such as cellulose fibers. In practice, mixtures of fillers are often used. The proportion of fillers in the powder paint composition is generally 20 to 95% by weight, preferably 30 to 60% by weight, based in each case on the total weight of the powder paint composition.

The formulation of a powder paint differs fundamentally from the formulation of a liquid paint due to the differences in the manufacturing process. A liquid paint is produced in a mixing reactor using a dispersing process. Fillers and pigments are exposed to high shear forces, which promote the disruption of particle agglomerates, improve the homogeneity of the liquid paint and the surface quality of the dried paint layer. This dispersion step takes several minutes to hours, depending on the construction and the desired quality of the paint.

A powder paint, by contrast, is fully formulated from dry components, and only water is added in the last step. If the water is added outside the paint production facility, it is not possible to disperse it using high-shear equipment. For the production of a paint immediately before application, the processor generally has a hand mixer with a mixing shaft and a few minutes at their disposal. The shear force that can be achieved in this way is insufficient to disrupt particle agglomerates and to achieve the desired degree of homogenization. For this reason, the filler and/or pigment components should be selected in such a way that these can be easily stirred with water at low shear force and comprise as few agglomerates as possible. When using fillers and pigments, attention should be paid to the surface finish. A rough surface with cavities supports agglomeration of particles. If an attempt is made to accelerate deagglomeration by adding an amphiphilic substance (dispersing agent), much more substance is required. Here, the substance requirement is calculated per area covered with a monolayer of amphiphilic molecules. The higher the roughness, the larger the surface area and the greater the need for dispersing agent. For powder paints, fillers that have already been surface-treated with an amphiphilic substance should be selected based on these considerations. These can be redispersed much more easily with less shear force and require less addition of dispersing agent.

In the case of liquid paints, fillers of different grain sizes are combined in order to achieve the densest possible packing and to improve coverage. The same approach can also be followed when formulating a powder paint, but fillers and pigments should be chosen with grain sizes that are as small as possible, preferably 0.1 to 2 µm. If small grain sizes are used, a similar coverage can be achieved even without bimodal grain size distribution. Fillers having a grain size of 0.20 to 0.35 µm are particularly preferred. Smaller grain sizes, on the other hand, do not require intensive redispersion in order to achieve a good, homogeneous surface quality.

Further additives c) are wetting and dispersing agents, thickeners, defoamers, hydrophobizing agents, film-forming auxiliaries and pH adjusters. Such additives are commercially available and the amounts used are known to those skilled in the art.

Examples of dispersing agents and wetting agents are sodium and potassium polyphosphates and polyacrylic acids and salts thereof. These are generally used in proportions of 0.1 to 1% by weight, based on the total weight of the powder paint composition.

Dispersing agents and wetting agents facilitate the dispersing process of pigments and fillers. At the molecular level, wetting and dispersing agents have an amphiphilic character, which means that one part of the molecule is hydrophilic and another lypophilic, or different parts of the molecule dissolve in media having different polarities or enter into interactions based on attraction with them. Amphiphilic molecules reach a thermodynamically more favorable state in the interfaces between media of different polarity. An example of such interfaces is the surface of a pigment or filler that is in an aqueous medium. Amphiphilic molecules are adsorbed on the surface of a pigment if they have appropriate groups that form interactions based on attraction with the pigment. The hydrophilic part of the molecule will adopt a favorable conformation towards the surrounding water. The surface energy of the pigment particle is reduced and wetting by water is favored. Due to the repulsive interactions between the hydrophilic parts of the molecule, the pigment particles are kept at a certain distance from one another. Thus, amphiphilic molecules support the wetting, dispersing and stabilization of pigment particles and filler particles in the water.

Depending on the nature of the hydrophilic groups, the wetting and dispersing agents are divided into ionic (cationic and anionic), non-ionic and amphoteric compounds. As a rule, macromolecular, ionic compounds are used as dispersing agents for the formulation of paints. However, due to their size, such molecules are resistant to diffusion and exhibit relatively slow wetting kinetics. In addition, ionic compounds react relatively sensitively to the presence of salts in the water, change their thermodynamic phase behavior and can lose stabilization capacity through ionic shielding. Ionic amphiphiles are poorly soluble in water at low temperatures, while non-ionic amphiphiles show exactly the opposite phase behavior and are soluble in water. The phase behavior of non-ionic amphiphiles only changes slowly when salt is added and can therefore have a good dispersion-stabilizing effect in media with high ion concentrations.

Based on these considerations, it is recommended to use a combination of ionic and non-ionic wetting and dispersing agents when formulating powder paints. Such a mixture shows excellent stabilization properties, and the surface tension and thus the surface energy can be reduced to a minimum through synergistic effects. Considering the wetting kinetics, a part of the amphiphile having a relatively low molar mass should be selected in order to accelerate wetting when water is added to powder paint due to the faster distribution kinetics in the bulk phase and adsorption kinetics on surfaces of pigments. The ratio between ionic and non-ionic amphiphilic components can be determined experimentally by measuring the quality of the paint after certain constant mixing times and energy input during stirring.

Examples of thickeners and protective colloids are cellulose ethers such as carboxymethyl cellulose, hydroxyethyl cellulose, starch and polyvinyl alcohol. Bentonite is an example of an inorganic thickener. The thickeners and protective colloids are generally used in an amount of 0.01 to 2% by weight each, based on the total weight of the powder paint composition.

In the case of thickeners, protective colloids and also defoamers and pH adjusters, the choice for powder paint is similar to that for liquid paint, but the substances should be available in powder form. The rheology of the powder paint differs from that of the liquid paint, especially in the high shear range, in that it is higher in this range. The selection of a thickener should therefore be made after measuring the rheological behavior.

Examples of hydrophobizing agents are silanes and fatty acid esters. Examples of defoamers are silicone oils, polyglycols.

Examples of film-forming auxiliaries are ester-alcohol mixtures such as Texanol^{R}.

Examples of modifiers are siliconates such as potassium methyl siliconates, amines, polyamines and polyethyleneimines.

Both formulations with and without pH adjusters, hydrophobizing agents and film-forming auxiliaries are possible.

To produce the powder paint composition, the individual constituents can be mixed with one another in the form of finely divided powders thereof in a powder mixer. Alternatively, it is also possible to proceed in such a way that the constituents b) and c) and optionally other additives of the powder paint composition are mixed together with the aqueous dispersion of the copolymer to produce the polymer powder redispersible in water a), and this aqueous mixture is then spray-dried. In this case, a powder paint composition is obtained which is characterized by particularly good dispersibility in water. The latter method is distinguished by the reduction in dust formation during the manufacture of the powder paint composition.

The powder paint composition is suitable for producing aqueous emulsion paints. For this purpose, the water content can be initially charged and the powder paint composition can be mixed into the water with stirring, or the procedure can be in reverse order, and optionally subsequently homogenized.

Compared to aqueous emulsion paints, the powder paint composition according to the invention is characterized by better storage stability. The powder paint composition is frost-stable, heat-stable, no skinning can occur, and the addition of biocide is dispensable. The powder paint composition has reduced packaging requirements compared to aqueous emulsion paints. No packaging in plastic buckets is required. When processing the powder paint composition, the exact amount of emulsion paint required can be produced. The use of the powder paint composition is therefore consumer-friendly and waste-free.

The advantage of dry powder paint lies in the fact that in-can preservation is no longer necessary for storage. If a liquid paint is prepared for use and is not used directly, it can be subsequently preserved. All common protection options can be used for this purpose, from adding conventional biocides to setting a high pH. The formulation for outdoor use can optionally be protected with fungicides and algicides, this taking the form of film protection.

The examples which follow serve to further illustrate the invention:

The advantages of the PVOH-stabilized, redispersible polymer powder (dispersion powder) in the production of emulsion paints were demonstrated when the polymer powders were tested in the paint formulation described in Table 1.

The formulation was prepared using (comparative) dispersion powders 1 to 5 and the viscosity values of the liquid paint were recorded. The paint was then applied and dried, and the measured values for opacity (OP) and abrasion resistance (AR) were determined from the applied samples.

Powder paint composition and water content for the emulsion paint:

TABLE 1

| Formulation constituent | Mass [g] |
|---|---|
| Powder paint | |
| Dispersion powder | 145.2 |
| TiO₂ pigment (Kronos 2190) | 60.6 |
| Wetting agent (METOLAT P 588) | 9.1 |
| CaCO₃ filler (Socal P2) | 358 |
| Cellulose fiber (Arbocel BE 600-30 PU) | 45.8 |
| Dispersing agent (Calgon N) | 3.0 |
| Thickener (Tylose MH 2.000 yp2) | 4.4 |
| Mass of powder paint | 626.1 |
| Emulsion paint | |
| Water | 373.9 |
| Mass of emulsion paint | 1000.0 |

The following dispersion powders were used for testing:

### Dispersion Powder 1 (DP 1)

Water-redispersible styrene-butyl acrylate copolymer powder (50% by weight styrene and 50% by weight n-butyl acrylate) with 20% by weight, based on the copolymer, of a polyvinyl alcohol mixture*.

### Dispersion Powder 2 (DP 2)

Water-redispersible methyl methacrylate-butyl acrylate copolymer powder (45% by weight methyl methacrylate and 55% by weight n-butyl acrylate) with 19% by weight, based on the copolymer, of a polyvinyl alcohol mixture*.

### Dispersion Powder 3 (DP 3)

Water-redispersible n-butyl acrylate-methyl methacrylate-vinyl laurate copolymer powder (45% by weight n-butyl acrylate, 40% by weight methyl methacrylate and 15% by weight vinyl laurate) with 10.5% by weight, based on the copolymer, of a polyvinyl alcohol mixture*.

### Dispersion Powder 4 (DP 4)

Water-redispersible n-butyl acrylate-methyl methacrylate-vinyl laurate copolymer powder (50% by weight n-butyl acrylate, 35% by weight methyl methacrylate and 15% by weight vinyl laurate) with 10.5% by weight, based on the copolymer, of a polyvinyl alcohol mixture*.

### Dispersion Powder 5 (DP 5)

Water-redispersible n-butyl acrylate-methyl methacrylate-vinyl laurate-glycidyl methacrylate-vinyltriethoxysilane copolymer powder (44.3% by weight n-butyl acrylate, 39.4% by weight methyl methacrylate and 14.7% by weight vinyl laurate and 0.8% by weight each of glycidyl methacrylate and vinyltriethoxysilane) with 10.5% by weight, based on the copolymer, of a polyvinyl alcohol mixture*.

### Comparative Dispersion Powder 6 (CDP 6)

Water-redispersible styrene-butyl acrylate copolymer powder (50% by weight styrene and 50% by weight n-butyl acrylate) with 17% by weight, based on the copolymer, of a polyvinyl alcohol having a degree of hydrolysis of 88 mol% and a Höppler viscosity of 4 mPas.

### Comparative Dispersion Powder 7 (CDP 7)

Water-redispersible styrene-acrylate copolymer powder which is stabilized with a naphthalenesulfonate formaldehyde protective colloid (Acronal S 735 P from BASF SE).

* polyvinyl alcohol mixture with a polyvinyl alcohol having a degree of hydrolysis of 88 mol% and a Höppler viscosity of 4 mPas and a polyvinyl alcohol having a degree of hydrolysis of 88 mol% and a Höppler viscosity of 13 mPas in a weight ratio of 2 : 1.

### Test Methods

Measurement of the Brookfield viscosities BF1, BF10 and BF100 of the emulsion paints:

The Brookfield viscosity of the emulsion paints produced with the powder paint compositions was measured in each case with a Brookfield viscometer BF 35, after heating to 23° C., in each case using the spindle specified in the operating instructions, at 1 revolution per minute (BF1), at 10 revolutions per minute (BF10) and at 100 revolutions per minute (BF100).

The measurements were taken immediately after mixing the emulsion paints. The viscosity is stated in mPas in each case.

Determination of the opacity OP of the emulsion paints:

The opacity was determined using the method according to DIN EN 13300 described in the “Guideline for determining the covering capacity” of the Association of the German Paint Industry, July 2002 edition.

The emulsion paints were applied using an automatic film applicator with a knife coater having a gap height of 150 µm and 225 µm, each on black-and-white contrast cards (type 3H from Lenetta) with a standard color value Y over black of 7 or less and a standard color value Y over white of 80 to 90.

The contrast cards coated in this way were dried for 24 hours at 23° C. and 50% relative air humidity and then weighed.

The yield in m2/l was calculated in each case from the application amount in g/m2 and the paint density.

The standard color values Y (color standards) were measured over the black and the white base using a colorimeter (Elrepho 450X from Datacolor) and the “contrast ratio” in “%” was calculated.

The values for the contrast ratio determined in this way were plotted on a diagram against the corresponding yield (m²/l). By interpolation, the opacity OP was determined at 7 m²/l at a contrast ratio of 98%.

Testing of the abrasion resistance AR (wet abrasion resistance) of the emulsion paints:

To determine the wet abrasion resistance, the emulsion paints produced from the powder paints were each tested using the nonwoven pad method according to ISO 11998.

The emulsion paint was in each case applied to a Leneta film (PVC film) using an applicator at a layer thickness of 300 µm (wet).

This was followed by storage for 72 hours in a standard climate (DIN 50014, 23° C. and 50% relative air humidity), then for 24 hours at 50° C. and finally for 24 hours in a standard climate.

A dry layer thickness of ca. 200 µm resulted.

Then three test strips each measuring 2.5 cm × 7.5 cm were cut out and then weighed.

The abrasion test was carried out for 200 cycles and then weighed again. The paint erosion in µm was then calculated from the paint density of the scrubbed area and the loss of mass of the paint film.

An average of three measurements was determined in each case.

The results of the measurements are summarized in Table 2:

TABLE 2

| Powder | BF1 mPas | BF10 mPas | BF100 mPas | OP | AR µm |
|---|---|---|---|---|---|
| DP 1 | 119200 | 22400 | 7050 | 97.4 | 35 |
| DP 2 | 62000 | 17320 | 5890 | 96.6 | 39 |
| DP 3 | 60800 | 18000 | 6350 | 96.0 | 30.3 |
| DP 4 | 65200 | 18320 | 6060 | 95.8 | 34.5 |
| DP 5 | 88800 | 23160 | 7170 | 96.1 | 21.3 |
| CDP6 | 49000 | 15400 | 6300 | 97.3 | 102 |
| CDP7 | 109400 | 17280 | 3760 | 96.2 | 99.6 |

Considering the values for viscosity, it can be seen, especially when shifting to higher shear rates, that the aqueous emulsion paints produced with the powder paints afford relatively high viscosity values. The shear thinning during application is therefore lower and higher layer thicknesses can be applied with one coat, which brings advantages in terms of opacity OP.

Abrasion resistance (wet abrasion) benefits from the proportion of the harder polymer polyvinyl alcohol, and lower abrasion values are obtained regardless of the composition of the acrylate polymer.

If the polyvinyl alcohol mixture used according to the invention is dispensed with, the abrasion resistance deteriorates dramatically.

The combination of epoxy-functional and silicon-functional comonomers provides an additional improvement in abrasion resistance.

The coverage values indicate the excellent dispersing ability of the polyvinyl alcohol, which comes into play in the powder paint formulation. Here, the polyvinyl alcohol also acts as a wetting and dispersing agent. The polyvinyl alcohol partially assumes the role of a dispersing agent and causes an improvement of the particle distribution when the powder paint is stirred into the water, promotes the disintegration of the particle agglomerates and thus causes an increase in the coverage of a powder paint.

1-11. (canceled)

12. A powder paint composition, comprising:
(a) at least one polymer powder redispersible in water;
(b) pigment and filler; and
(c) optionally further additives;
wherein the polymer powder redispersible in water (a) is a polymer stabilized with polyvinyl alcohol, based on
(a1) 20 to 100% by weight of at least one monomer from the group consisting of acrylic esters of branched or unbranched alcohols having 1 to 12 carbon atoms,
(a2) 0 to 60% by weight of at least one monomer from the group consisting of methacrylic esters of branched or unbranched alcohols having 1 to 12 carbon atoms and styrene,
(a3) 0 to 40% by weight of at least one monomer from the group consisting of vinyl esters of branched or unbranched carboxylic acids having 2 to 12 carbon atoms,
(a4) 0 to 20% by weight of other ethylenically unsaturated comonomers copolymerizable therewith; and
wherein in each case on the total weight of the comonomers and where the figures in % by weight add up to 100% by weight in each case, and the polyvinyl alcohol present is a mixture of at least one polyvinyl alcohol having a degree of hydrolysis of 80 to 95 mol% and a Höppler viscosity (4% aqueous solution, Höppler method at 20° C., DIN 53015) of 1 to 5 mPas and at least one polyvinyl alcohol having a degree of hydrolysis of 80 to 95 mol% and a Höppler viscosity of 6 to 40 mPas.

13. The powder paint composition claim 111, wherein a polymer based on 90 to 100% by weight of at least one monomer (a1) and optionally also 0.1 to 10% by weight of one or more auxiliary monomers (a4) is present.

14. The powder paint composition of claim 11, wherein a polymer based on 30 to 70% by weight of at least one monomer (a1), 30 to 60% by weight of at least one monomer (a2) and optionally also 0.1 to 10% by weight of one or more auxiliary monomers (a4) is present.

15. The powder paint composition of claim 11, wherein a polymer based on 30 to 70% by weight of at least one monomer (a1), 30 to 60% by weight of at least one monomer (a2), 5 to 40% by weight of at least one monomer (a3), and optionally also 0.1 to 10% by weight of one or more auxiliary monomers (a4) is present.

16. The powder paint composition of claim 11, wherein epoxide-functional or silicon-functional comonomers, and combinations of epoxide-functional and silicon-functional comonomers are present as auxiliary monomers (a4).

17. The powder paint composition of claim 11, wherein the polymer powder redispersible in water (a) has a polyvinyl alcohol content of 2 to 30% by weight, based on the weight of the polymer.

18. The powder paint composition of claim 11, wherein the polymer powder redispersible in water (a) has an increased polyvinyl alcohol content of 20 to 30% by weight, and is used alone or in a mixture with a polymer powder redispersible in water (a) having a lower polyvinyl alcohol content, in the powder paint composition.

19. The powder paint composition of claim 11, wherein the powder paint composition comprises one or more hydraulic binders.

20. The powder paint composition of claim 11, wherein the powder paint composition is used for producing aqueous emulsion paints.

21. A process for producing a powder paint composition, comprising:
providing a powder paint composition, wherein the powder paint composition comprises
(a) at least one polymer powder redispersible in water;
(b) pigment and filler; and
(c) optionally further additives;
wherein the polymer powder redispersible in water (a) is a polymer stabilized with polyvinyl alcohol, based on
(a1) 20 to 100% by weight of at least one monomer from the group consisting of acrylic esters of branched or unbranched alcohols having 1 to 12 carbon atoms,
(a2) 0 to 60% by weight of at least one monomer from the group consisting of methacrylic esters of branched or unbranched alcohols having 1 to 12 carbon atoms and styrene,
(a3) 0 to 40% by weight of at least one monomer from the group consisting of vinyl esters of branched or unbranched carboxylic acids having 2 to 12 carbon atoms,
(a4) 0 to 20% by weight of other ethylenically unsaturated comonomers copolymerizable therewith,
wherein in each case on the total weight of the comonomers and where the figures in % by weight add up to 100% by weight in each case, and the polyvinyl alcohol present is a mixture of at least one polyvinyl alcohol having a degree of hydrolysis of 80 to 95 mol% and a Höppler viscosity (4% aqueous solution, Höppler method at 20° C., DIN 53015) of 1 to 5 mPas and at least one polyvinyl alcohol having a degree of hydrolysis of 80 to 95 mol% and a Höppler viscosity of 6 to 40 mPas; and
mixing the individual constituents with one another in the form of finely divided powders thereof in a powder mixer.

22. A process of claim 21, wherein the constituents (b) and (c) of the powder paint composition are mixed together with the aqueous dispersion of the polymer to produce the polymer powder redispersible in water (a), and the aqueous mixture is then spray-dried.

23. The process of claim 21, wherein the powder paint composition produced is used for producing aqueous emulsion paints.
